(19) United States
(12) Patent Application Publication
(10) Pub. No.: US 2026/0045682 A1
(43) Pub. Date: Feb. 12, 2026

(54) VEHICLE ANTENNA ASSEMBLY WITH EXPOSED GROUND PLANE

(71) Applicant: Ford Global Technologies, LLC, Dearborn, MI (US)

(72) Inventor: Nemer Nemer, Dearborn, MI (US)

(21) Appl. No.: 18/797,632

(22) Filed: Aug. 8, 2024

(51) Int. Cl. H01Q 1/32; H01Q 1/48

(52) U.S. Cl. CPC H01Q 1/3275; H01Q 1/48

(57) ABSTRACT

A vehicle antenna assembly includes a vehicle structure having a recessed area, and an antenna assembly having a ground plane received within the recessed area. A vehicle antenna assembly includes a ground plane that has an exposed section that provides a visible exterior surface of a vehicle, at least one antenna extending from the ground plane, and an enclosure covering the at least one antenna without covering the exposed section.

### TECHNICAL FIELD

This disclosure relates generally to an antenna assembly for a vehicle, and more particularly, to a ground plane of an antenna assembly.

### BACKGROUND

Vehicles can include an antenna assemblies facilitating communication to and from the vehicle. Antenna assemblies can include ground planes. In the past, ground planes have been embedded within and completely covered by vehicle structures, such as a vehicle roof.

### SUMMARY

In some aspects, the techniques described herein relate to a vehicle antenna assembly, including: a vehicle structure having a recessed area; and an antenna assembly having a ground plane received within the recessed area.

In some aspects, the techniques described herein relate to a vehicle antenna assembly, wherein the vehicle structure is a vehicle spoiler.

In some aspects, the techniques described herein relate to a vehicle antenna assembly, wherein the vehicle structure is a vehicle roof.

In some aspects, the techniques described herein relate to a vehicle antenna assembly, wherein the vehicle structure is a rear hatch of a vehicle.

In some aspects, the techniques described herein relate to a vehicle antenna assembly, wherein the ground plane is exposed.

In some aspects, the techniques described herein relate to a vehicle antenna assembly, wherein the ground plane provides a class-A surface.

In some aspects, the techniques described herein relate to a vehicle antenna assembly, wherein the ground plane is painted.

In some aspects, the techniques described herein relate to a vehicle antenna assembly, wherein the ground plane provides a class-A surface of a vehicle.

In some aspects, the techniques described herein relate to a vehicle antenna assembly, wherein the ground plane provides a visible, exterior surface of a vehicle.

In some aspects, the techniques described herein relate to a vehicle antenna assembly, wherein the ground plane is adhesively secured to the vehicle structure.

In some aspects, the techniques described herein relate to a vehicle antenna assembly, wherein an outer surface of the vehicle structure is flush with an outer surface of the ground plane.

In some aspects, the techniques described herein relate to a vehicle antenna assembly, wherein the ground plane is aluminum or aluminum alloy.

In some aspects, the techniques described herein relate to a vehicle antenna assembly, further including at least one antenna extending upward from the ground plane.

In some aspects, the techniques described herein relate to a vehicle antenna assembly, further including an enclosure covering the at least one antenna.

In some aspects, the techniques described herein relate to a vehicle antenna assembly, including: a ground plane that having an exposed portion that provides a visible exterior surface of a vehicle; at least one antenna extending from the ground plane; and an enclosure covering the at least one antenna without covering the exposed section.

In some aspects, the techniques described herein relate to a vehicle antenna assembly, wherein the ground plane is configured to be recessed within a vehicle structure.

In some aspects, the techniques described herein relate to a vehicle antenna assembly, wherein the ground plane is adhesively bonded to the vehicle structure.

In some aspects, the techniques described herein relate to a vehicle antenna assembly, wherein the vehicle structure is a vehicle spoiler.

In some aspects, the techniques described herein relate to a vehicle antenna assembly, wherein the ground plane is painted.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a portion of a vehicle showing a vehicle antenna assembly of the vehicle.

FIG. 2 illustrates a close-up view of an area of FIG. 1 showing the vehicle antenna assembly.

FIG. 3 illustrates the close-up view of the area shown in FIG. 2 with portions expanded.

### DETAILED DESCRIPTION

This disclosure relates generally to antennas assemblies for vehicles and, in particular, to packaging a ground plane for an antenna assembly of a vehicle. Examples of this disclosure utilize a ground plane that is exposed and visible to an observer viewing an exterior of the vehicle.

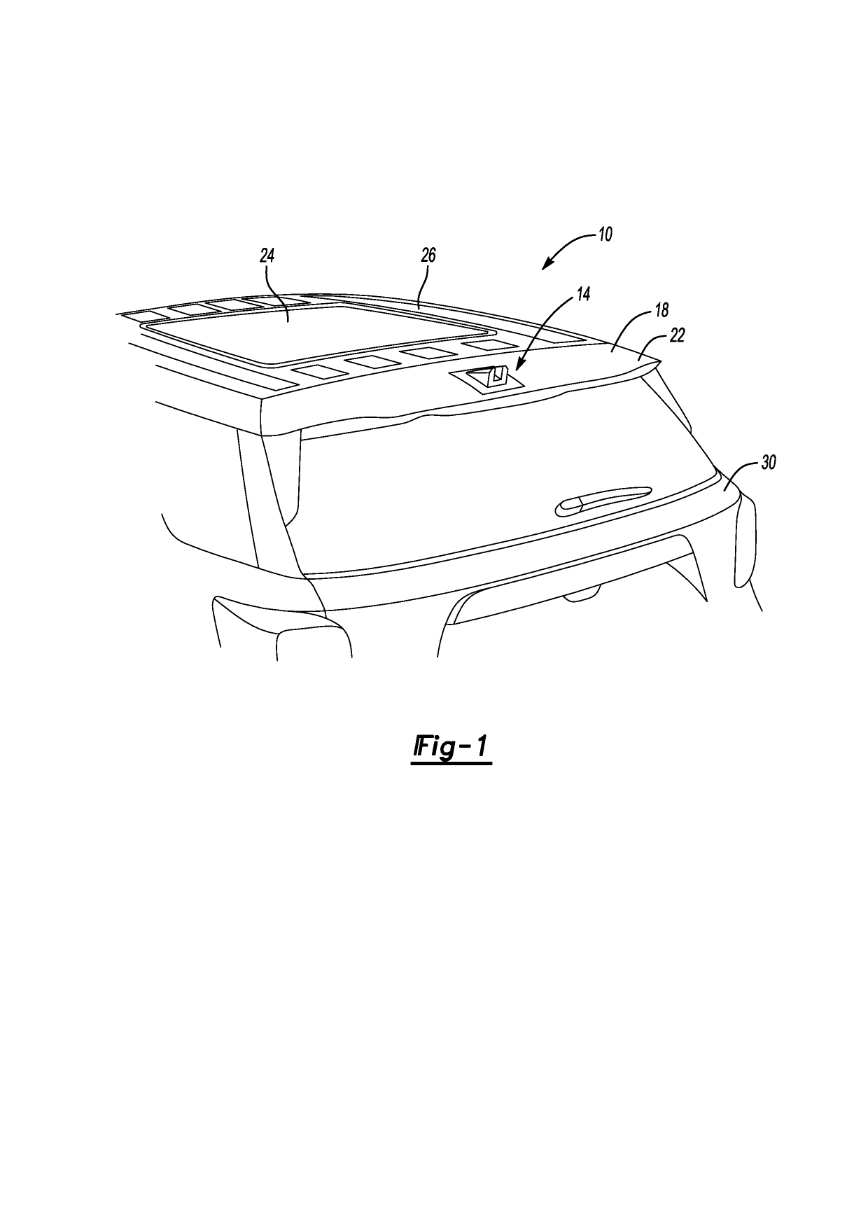

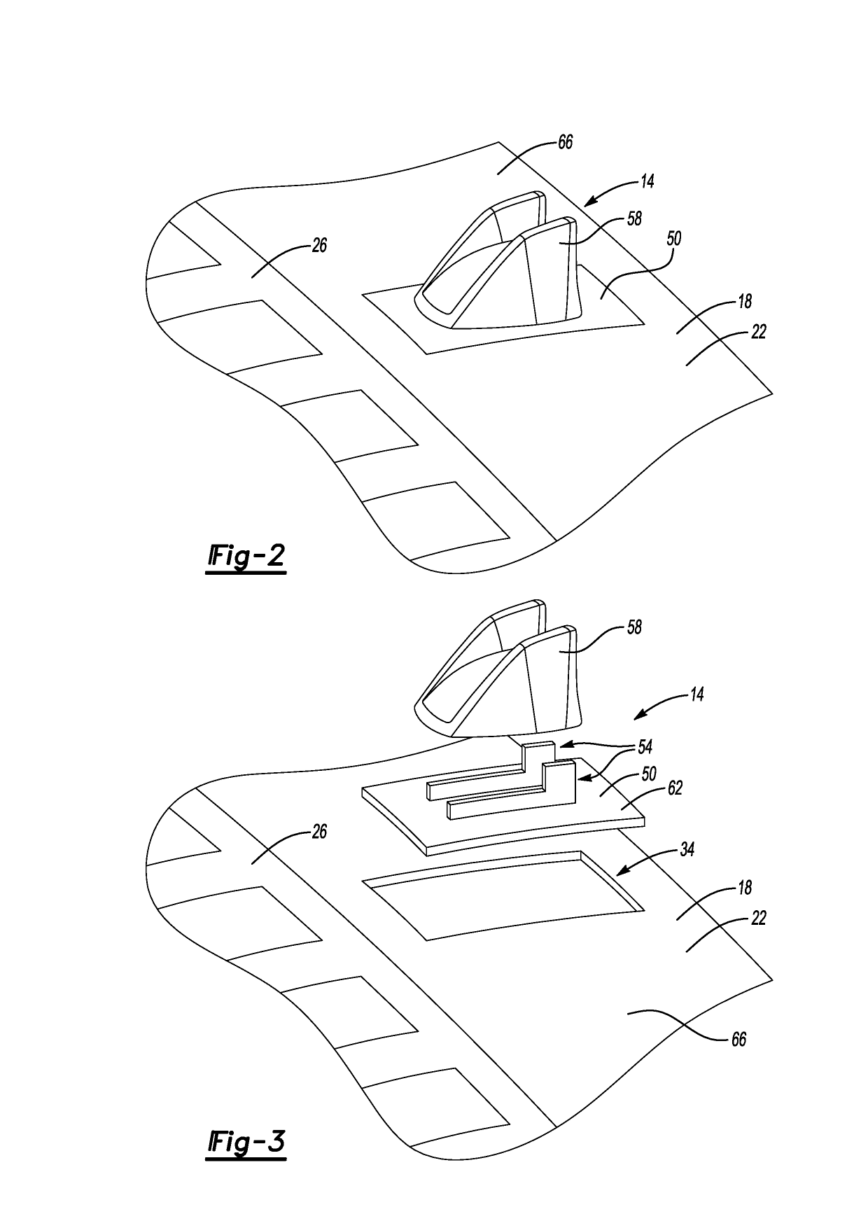

With reference to FIGS. 1 to 3, an example vehicle 10 includes an antenna assembly 14 secured to a vehicle structure 18. In this example, the vehicle structure 18 is a piece of exterior trim and, in particular, a rear spoiler 22. Securing the antenna assembly 14 to the rear spoiler 22 provides more space for a panoramic glass moonroof 24.

In another example, the antenna assembly 14 could be secured to another vehicle structure 18 such as a roof 26 or a liftgate 30 of the vehicle 10. In another example, the antenna assembly 14 could be secured to a decklid.

The vehicle structure 18 includes a recessed area 34. The antenna assembly 14 is secured within the recessed area 34.

In particular, the example antenna assembly 14 includes a ground plane 50, at least one antenna 54, and an enclosure 58. The at least one antenna 54 extends vertically upward from the ground plane 50. Vertical, for purposes of this disclosure, is with reference to ground and a generally orientation of the vehicle 10 during operation.

The ground plane 50 can be an aluminum or an aluminum alloy. The ground plane 50 has an outer surface 62. The spoiler 22 can be a polymer-based material. The spoiler has an outer surface 66. The ground plane 50 is received within the recessed area 34 when the antenna assembly 14 is secured to the spoiler 22. The antenna assembly 14 is, in this example, secured to the spoiler 22 within the recessed area 34 such that the outer surface 62 of the ground plane 50 is substantially flush with an outer surface 66 of the spoiler 22.

The enclosure 58 covers the at least one antenna 54 and some portions of the outer surface 62. Other portions of the ground plane 50 and the outer surface 62 extend further from the at least one antenna 54 and are not covered by the enclosure 58. A portion of the ground plane 50 thus provides a visible exterior surface of the spoiler 22. This portion of the ground plane 50 can be said to be exposed and, to provide a class-A surface for the vehicle 10.

The ground plane 50 can be painted to match the outer surface 66 of the spoiler 22. In this example, the ground plane 50 is adhesively secured within the recessed area 34. The ground plane 50 could be bonded to the spoiler 22 within the recessed area 34 utilizing adhesives alone, or some combination of adhesives and mechanical fasteners.

Examples of this disclosure include providing an antenna assembly for a vehicle having a ground plane that is exposed rather than being entirely embedded within a vehicle structure. The exposure of the ground plane can provide design flexibility as accommodating the ground plane at a position embedded within the vehicle structure is not necessary.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle antenna assembly, comprising:
a vehicle structure having a recessed area; and
an antenna assembly having a ground plane received within the recessed area.

2. The vehicle antenna assembly of claim 1, wherein the vehicle structure is a vehicle spoiler.

3. The vehicle antenna assembly of claim 1, wherein the vehicle structure is a vehicle roof.

4. The vehicle antenna assembly of claim 1, wherein the vehicle structure is a rear hatch of a vehicle.

5. The vehicle antenna assembly of claim 1, wherein the ground plane is exposed.

6. The vehicle antenna assembly of claim 1, wherein the ground plane provides a class-A surface.

7. The vehicle antenna assembly of claim 1, wherein the ground plane is painted.

8. The vehicle antenna assembly of claim 1, wherein the ground plane provides a class-A surface of a vehicle.

9. The vehicle antenna assembly of claim 1, wherein the ground plane provides a visible, exterior surface of a vehicle.

10. The vehicle antenna assembly of claim 1, wherein the ground plane is adhesively secured to the vehicle structure.

11. The vehicle antenna assembly of claim 1, wherein an outer surface of the vehicle structure is flush with an outer surface of the ground plane.

12. The vehicle antenna assembly of claim 1, wherein the ground plane is aluminum or aluminum alloy.

13. The vehicle antenna assembly of claim 1, further comprising at least one antenna extending upward from the ground plane.

14. The vehicle antenna assembly of claim 13, further comprising an enclosure covering the at least one antenna.

15. A vehicle antenna assembly, comprising:
a ground plane that having an exposed portion that provides a visible exterior surface of a vehicle;
at least one antenna extending from the ground plane; and
an enclosure covering the at least one antenna without covering the exposed portion.

16. The vehicle antenna assembly of claim 15, wherein the ground plane is configured to be recessed within a vehicle structure.

17. The vehicle antenna assembly of claim 16, wherein the ground plane is adhesively bonded to the vehicle structure.

18. The vehicle antenna assembly of claim 16, wherein the vehicle structure is a vehicle spoiler.

19. The vehicle antenna assembly of claim 15, wherein the ground plane is painted.
